(19) United States
(12) Patent Application Publication
(10) Pub. No.: US 2020/0099186 A1
(43) Pub. Date: Mar. 26, 2020

(54) CARBON HOLDER PLATE FOR AN ELECTRIC MOTOR, WINDSHIELD WIPER MOTOR, AND METHOD FOR MOUNTING A WINDSHIELD WIPER MOTOR

(71) Applicant: Valeo Systemes D'Essuyage, La Verriere (FR)

(72) Inventor: Siegfried Stefani, Bietigheim-Bissingen (DE)

(21) Appl. No.: 16/612,463

(22) PCT Filed: May 15, 2018
(86) PCT No.: PCT/EP2018/062624

§ 371 Date: Nov. 11, 2019

(30) Foreign Application Priority Data
May 15, 2017 (DE) 10 2017 110 470.4

(51) Int. Cl. H01R 39/38; H01R 39/42

(52) U.S. Cl. CPC H01R 39/381; H01R 39/42

(57) ABSTRACT

The invention relates to a carbon holder plate for an electric motor, comprising a guide element for a carbon brush, wherein the carbon brush is longitudinally displaceable arranged in the guide element in the direction of a longitudinal axis of the carbon brush, a first end face of the carbon brush, which is designed to rest against a collector of the electric motor, a second end face located opposite the first end face, against which in an operational state, a spring element rests under spring tension in order to press the carbon brush in the direction of the collector, and a device for positioning the first end face of the carbon brush in a mounting position of the carbon holder plate at a distance from the collector.

### PRIOR ART

The invention relates to a carbon holder plate for an electric motor as claimed in the preamble of claim 1. The invention furthermore relates to an electric motor, to a windshield wiper motor having a carbon holder plate according to the invention, as well as to a method for assembling a windshield wiper motor.

A brush holder plate for an electric motor having the features of the preamble of claim 1 is already well known in practice. In the case of an electric motor equipped with a brush holder plate of this type, the carbon brushes that are disposed so as to be longitudinally displaceable in the region of the carbon holder plate in the operation of the electric motor bear on the segments of the collector of the armature of the electric motor. When assembling the electric motor as a component part of a windshield wiper motor, the carbon holder plate is fastened to a gear housing of the windshield wiper motor in an intermediate assembling step. It is subsequently necessary for the armature, by way of the armature shaft thereof, which on the side that faces the gear housing has a drive pinion, to be guided through a through opening of the carbon holder plate until the segments of the collector are situated on the armature shaft so as to be level with the carbon brushes. During this preliminary assembling, it is important that the carbon brushes are disposed in a position that is recessed in comparison to the operating position and spaced apart from the collector, so that the carbon brushes when axially joining the armature shaft do not come into contact with the armature shaft or the collector, respectively, and are potentially damaged in the process. To this end, use is typically made, for example, of an auxiliary installation which, when axially joining the armature shaft, holds the carbon brushes counter to the spring force of spring elements which push the carbon brushes in the direction of the collector in a recessed position. This auxiliary installation which represents a separate component in an additional assembling step is subsequently moved out of contact with the carbon brushes again, on account of which the carbon brushes are brought so as to contact the collector in a manner abutting thereon.

Moreover, conical additional elements which in the joining direction of the armature shaft are disposed on that side that faces away from the armature coils on the end side of the collector and which after the assembling can remain in the electric motor, or the windshield wiper motor, respectively, are known in the prior art. When joining the armature shaft, the end faces of the carbon brushes that face the armature shaft come into contact with the additional element and are axially pressed outward by the additional element. Depending on the size of the angle on the addition element, undesirably high loads can arise on the end faces of the carbon brushes in this case, in particular when the additional element impacts the end faces of the carbon brushes at a high speed, or with a great impulse, respectively when assembling.

### DESCRIPTION OF THE INVENTION

The carbon holder plate according to the invention for an electric motor having the features of claim 1 has the advantage that an axially recessed positioning of the carbon brushes during the assembling of an electric motor, or the axial joining of the armature shaft to the carbon holder plate, respectively, is achievable without additional separate components.

The invention is based on the concept of utilizing the spring elements which are present for applying the required contact pressure of the carbon brushes to the collector so as to dispose said spring elements in the assembling position so as to be operatively connected to a lateral surface of the carbon brushes in such a manner that the carbon brushes in the guide elements thereof, on account of the spring pretensioning of the spring elements, are pushed in the direction of the lateral wall of the respective guide element that is opposite the spring element, wherein the contact pressure on account of the spring element is so high that a friction-locked connection is configured between the carbon brush and the guide element, said friction-locked connection holding the carbon brush in a position in which the end face of the carbon brush that faces the collector is disposed so as to be spaced apart from the armature shaft, or from the collector, respectively.

Advantageous refinements of the carbon holder plate according to the invention for an electric motor are set forth in the dependent claims. All combinations from at least two features disclosed in the claims, the description, and/or the figures are within the scope of the invention.

A tripping device is provided for the carbon brush in the assembling of the electric motor to be moved from the position of said carbon brush that is spaced apart from the collector so as to contact the collector in an abutting manner. The tripping device has a contact element which is movable so as to contact the second end face of the carbon brush that faces away from the collector in an abutting manner and which, upon contact with the second end face and further movement of the contact element, displaces the contact brush in the guide element in the direction of the longitudinal axis toward the collector such that the spring element can enter into an operative connection with the second end face of the carbon brush.

In a refinement of the last proposal, it is provided that the second end face of the carbon brush and/or the contact element of the tripping device in the abutting region between the carbon brush and the contact element are/is arranged at an oblique angle relative to the longitudinal axis, or has a bevel. A design embodiment of this type has the effect that a continuous, that is to say jolt-free, transition from the spring element in the direction of the second end face of the carbon brush is enabled in the longitudinal displacement of the carbon brush in the guide element, and that moreover the spring element can follow the geometry of the carbon brush in a particularly simple manner when the spring element sweeps or moves, respectively, along the carbon brush, and splintering or similar from the carbon brush can be avoided.

In order for the desired movement of the contact element of the tripping device along the carbon brush to be enabled, it is provided that the contact element is arranged elastically on the tripping installation by means of a spring portion. A configuration of this type moreover enables the tripping device to be configured integrally in the form of a plastic injection-molded part in a particularly simple manner.

In an again preferred refinement of the last proposal, said refinement enabling particularly simple, cost-effective, and precise manufacturing of the carbon holder plate as well as of the tripping device, it is proposed that the carbon holder plate is made of plastic, and that the contact element is formed monolithically on the carbon holder plate over the spring portion.

In order for a targeted movement of the contact element on the carbon brush be enabled, said movement being dependent on the assembling of the components of the electric motor, it is provided that the tripping device comprises an entrainment element arranged in an operative connection with the contact element. Said entrainment element in the assembling of the individual parts of the electric motor typically comes into contact with a counter element in a manner abutting thereon, for example a motor housing, and in the assembling of the motor housing is conjointly moved in a manner corresponding to the movement of the motor housing on account of which the contact element in the desired manner simultaneously effects the movement of the carbon brush in the guide element.

In order to avoid damage to the carbon brush, which could lead to splintering or similar, in particular in the movement of the spring element along the surface of the carbon brush, it is furthermore preferably provided that the spring element comprises a curved contact portion which can be placed both against the lateral surface as well as against the second end face of the carbon brush that faces away from the collector of the armature. Said contact portion configured in a curved manner in the movement of the carbon brush in the guide element slides along the lateral surface of the carbon brush and subsequently makes its way into the region of the second end face of the carbon brush.

The invention also relates to an electric motor with an armature comprising a commutator and a carbon holder plate which is constituted in a manner according to the invention.

In order to enable a forced actuation of the tripping device, or the carbon brush coming into contact with the collector, respectively, in the assembling of the components of the electric motor, it is provided in one preferred design embodiment of the electric motor that the electric motor comprises a motor housing which can be connected to a gear housing, and that an actuating portion which can be positioned against a movably arranged entrainment element of the tripping device is provided on the motor housing.

The invention furthermore comprises a windshield wiper motor with an electric motor described above.

A method for assembling a windshield wiper motor according to the invention provides at least the following assembling steps: first, pre-assembling of the carbon holder plate on the gear housing of the windshield wiper motor takes place, wherein the carbon brush is arranged in an assembly position which is spaced apart from the collector of the electric motor. Subsequently, axial joining of the armature and of the motor housing in the direction toward the gear housing takes place, wherein the armature is moved with a spacing past the carbon brush. Finally, bringing into contact the actuation portion of the motor housing and relatively moving the latter with the entrainment element of the tripping device takes place, wherein the carbon brush is moved in the guide element in the direction of the collector, and wherein the spring element comes into contact with the second end face of the carbon brush that faces away from the collector and herein presses the carbon brush against the collector.

Further advantages, features, and details of the invention are derived from the description hereunder of preferred exemplary embodiments and by means of the drawing in which:

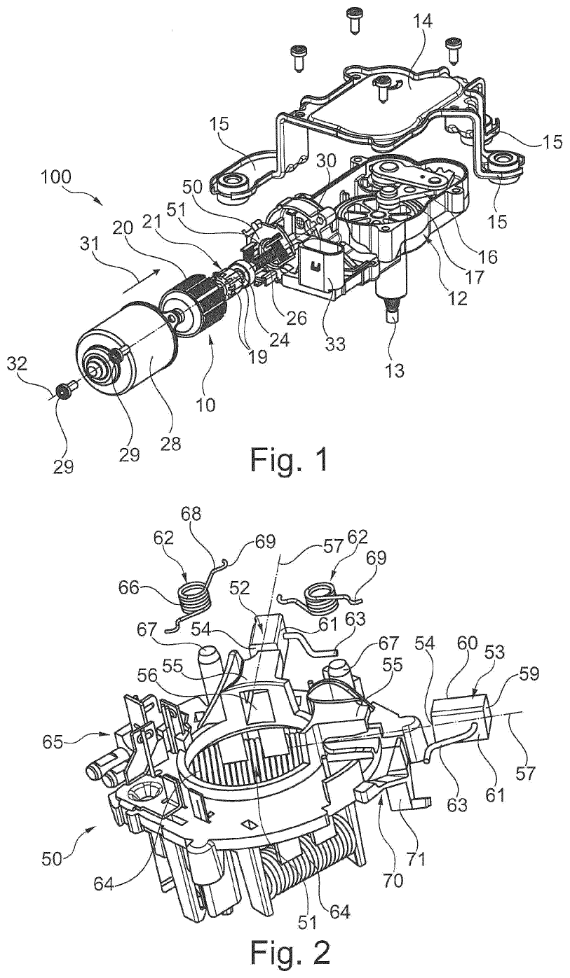

FIG. 1 shows the essential components of the windshield wiper motor in an exploded illustration;

FIG. 2 shows a perspective illustration of the essential components of a carbon holder plate according to the invention;

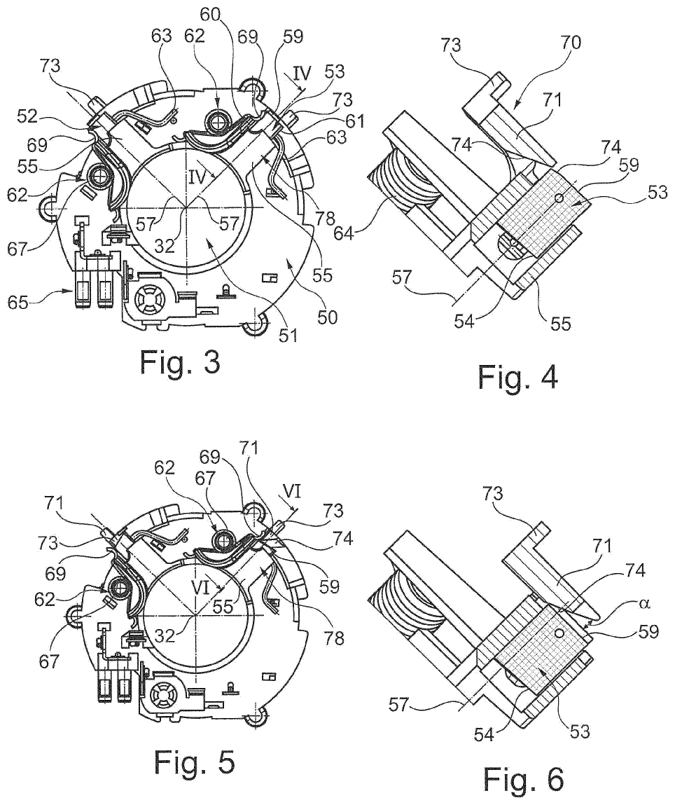

FIG. 3 shows a plan view of the carbon holder plate according to FIG. 2 in a pre-assembly position in which the carbon brushes are arranged in a locked position so as to be spaced apart from the collector of the electric motor;

FIG. 4 shows a section in the plane IV-IV of FIG. 3;

FIG. 5 shows a plan view of the carbon holder plate according to the illustration of FIG. 3, in which deblocking of the carbon brushes takes place;

FIG. 6 shows a section in the plane VI-VI of FIG. 5;

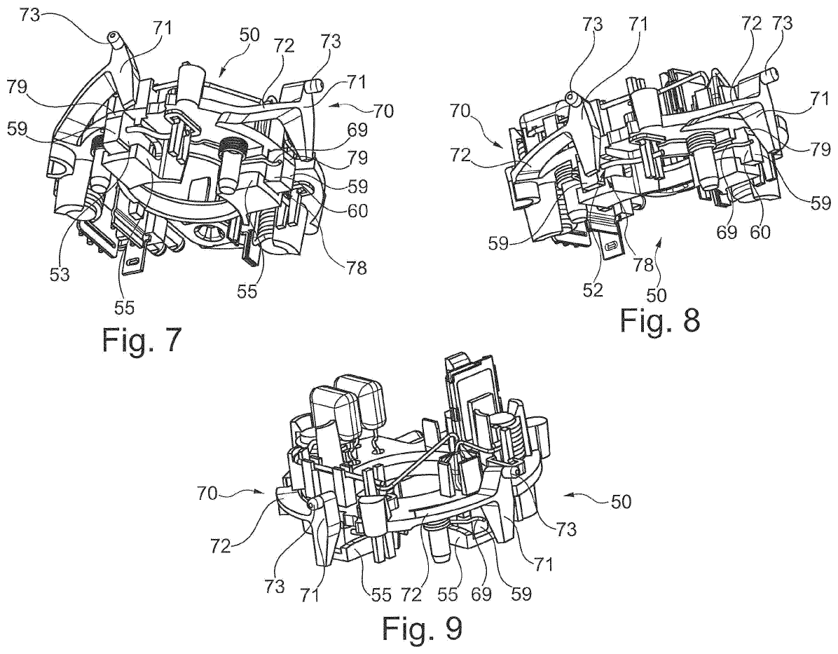

FIG. 7

to

FIG. 9 show in each case in a perspective view the carbon holder plate according to FIG. 2 during various phases in the assembly of an electric motor;

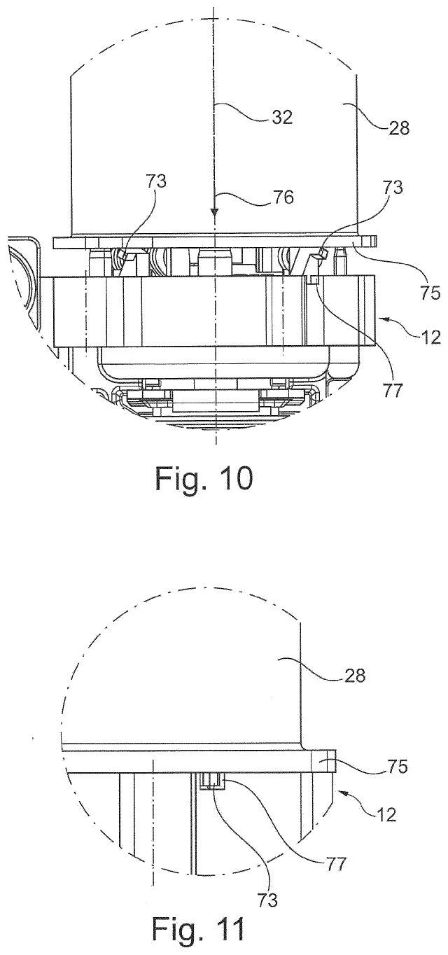

FIG. 10 shows a lateral view of a sub-region of the windshield wiper motor of FIG. 1; and

FIG. 11 shows a detail of FIG. 10 in an enlarged illustration in the final assembled state of the windshield wiper motor.

In the figures, the same elements, or elements with equivalent functions, respectively, are provided with the same reference signs.

The essential components of a windshield wiper motor 100 for wiping a vehicle glass are illustrated in FIG. 1. The windshield wiper motor 100 comprises an electric motor 10 which is capable of being flange-fitted to a gear housing 12. An output shaft 13 which is capable of being at least indirectly connected to a windshield wiper protrudes from the gear housing 12. The gear housing 12 on the side that is opposite the output shaft 13 is capable of being closed by means of a gear cover 14, wherein the windshield wiper motor 100 by way of connector regions 15 that are arranged on the gear cover 14 can simultaneously be connected to the body of the vehicle. A gear 16 which comprises a gear wheel 17 is arranged within the interior space of the gear housing 12, wherein the gear wheel 17 by way of a toothing that is arranged on the external circumference of the gear wheel 17 is capable of being driven by the electric motor 10.

The electric motor 10 has an armature 20, the armature coils thereof (not illustrated) being connected to segments 19 of a collector 21. The collector 21 is a component part of a commutator. The armature 20 furthermore comprises an armature shaft 24 which on the side that faces the gear housing 12 comprises a portion with a worm splining 26. The worm splining 26 in the case of an assembled windshield wiper motor 100 serves for meshing, or interacting, respectively, with the toothing on the gear wheel 17. To this end, the armature shaft 24 at least by way of the region of the worm splining 26 protrudes into the region of the toothing of the gear wheel 17 in the interior space of the gear housing 12.

The electric motor 10 furthermore comprises a motor housing 28 which is referred to as a pole pot housing, usually composed of sheet metal and produced by the deep-drawing method, and which by means of fastening screws 29 is connectable to the gear housing 12 by way of threaded bores 30 provided on the gear housing 12.

The electric motor 10 comprises a carbon holder plate 50 illustrated in a detailed illustration in FIG. 2. With reference to FIG. 1, it is explained that the assembly of an electric motor 10 described above takes place substantially in that the armature 20, conjointly with the motor housing 28, in the case of a carbon holder plate 50 pre-assembled on the gear housing 12, by way of the portion of the armature shaft 24 that comprises the worm splining 26, is connected axially to the gear housing 12 in the direction of the arrow 31. The armature shaft 24 herein is guided through a through opening 51 that is configured on the carbon holder plate 50 until the armature 20 has reached an axial position at which the collector 21 of the armature 20 is situated so as to be level with the carbon holder plate 50. Finally, the motor housing 28 is screw-fitted to the gear housing 12, and the gear cover 14 is fastened to the gear housing 12.

In the assembling of the electric motor 10, or of the armature 20, respectively, on the gear housing 12, it is essential that carbon brushes 52, 53 that are provided in the region of the carbon holder plate 50, as a component part of the commutator, by way of the first end faces 54 of said carbon brushes 52, 53 that face the collector 21, are arranged in an assembly position so as to be spaced apart from the collector 21 of the armature 20, in which assembly position the first end faces 54 cannot come into contact so as to abut on the armature shaft 24 and the segments 19 of the collector 21. On account thereof, a collision between the carbon brushes 52, 53 and component parts of the armature 20, and thus any damage or preliminary damage to the carbon brushes 52, 53, is avoided.

From this assembly position during the introduction of the armature 20 into the gear housing 12, the carbon brushes 52, 53 for operating the electric motor 10, or the windshield wiper motor 100, respectively, have to be moved to an operating position in which the first end faces 54 of the carbon brushes 52, 53 are situated so as to contact in an abutting manner the segments 19 of the collector 21. To this end, the carbon holder plate 50 is of a particular design, as is yet to be explained in more detail hereunder.

The carbon holder plate 50 illustrated in FIG. 2 is made of plastic and is configured as an injection-molded part. The carbon holder plate 54 in each carbon brush 52, 53 comprises one guide element 55 which is molded so as to be integral to the carbon holder plate 50 and comprises an opening cross section 56 which is adapted to the external cross section of the carbon brush 52, 53 and is in particular configured so as to be rectangular or square.

Within the guide elements 55, the carbon brushes 52, 53 are arranged so as to be displaceable in the direction of the longitudinal axes 57 of the guide elements 55, or of the carbon brushes 52, 53, respectively. As can be seen by means of FIG. 2, the guide elements 55 in an exemplary manner open out in the region of the through opening 51 such that the first end faces 54 of the carbon brushes 52, 53 that protrude from the opening cross section 56 in the direction toward the through opening 51 can be arranged so as to contact the segments 19 of the collector 21 of the armature 20 in an abutting manner when the collector 21 is situated so as to be axially congruent with the first end faces 54 of the carbon brushes 52, 53, wherein the axial congruence refers to the axial position of the longitudinal axis 32 of the armature shaft 24, as can be seen in FIG. 1.

Apart from the first end face 54 that faces the collector 21, each carbon brush 52, 53 on the side opposite the first end face 54 moreover comprises a second end face 59 as well as four lateral surfaces, wherein the one lateral surface 61 which is situated on a side that faces away from that spring element 52 is particularly relevant to the understanding of the invention.

Moreover, a connector braid 63 of the carbon brush 52, 53 can be seen in FIG. 2, said connector braid 63 by way of a suppression choke 64 in an exemplary manner being connected to a connector port 65 by way of which in turn the electrical actuation of the electric motor 10 takes place by way of a connector plug 33 that is arranged on the gear housing 12.

The spring element 62 has a portion 66 which comprises a plurality of coilings and by way of which the spring element 62 by means of a pin-shaped appendage 67 that is arranged on the carbon holder plate 50 is positioned. The spring element 62 is configured as a leg spring and comprises at least one spring portion 68 that protrudes away from the portion 66 and comprises as a contact portion an end portion 69 curved in a circular manner, wherein the end portion 69 is configured for interacting with the lateral surface 60 opposite the lateral surface 61 as well as with the second end face 59 of the carbon brush 52, 53.

Furthermore, a tripping device 70 is integrally molded on the carbon holder plate 50, said tripping device 70 comprising for each carbon brush 52, 53 one substantially rigid contact element 71 which by way of an elastically configured spring portion 72 (FIGS. 7 to 9) is connected to the external circumference of the carbon holder plate 50. In the region of the contact element 71, the tripping device 70 moreover comprises an entrainment element 73 which in relation to the carbon holder plate 50 protrudes radially outward.

As can be seen in particular by means of the illustration of FIGS. 4 and 6, the contact element 71 on the side that faces the carbon brush 52, 53 comprises a contact face 74 which in relation to a plane that runs perpendicularly to the longitudinal axis 57 is arranged at an angle α of, for example, between 10° and 45°. The second end face 59 on the side that faces the contact element 71 also comprises a bevel 79 which is approximately reciprocal to the contact face 74.

It can be seen by means of FIGS. 10 and 11 that the motor housing 28 on the side that faces the gear housing 21 as an actuation portion has a portion 75 which is encircling in the manner of a flange and which is arranged in such a manner that said portion 75, when axially joining the motor housing 28 in the direction of the gear housing 12, in the direction of the arrow 76 (FIG. 10) comes into contact in an abutting manner with the entrainment element 73 and herein moves the entrainment element 73 conjointly with the contact element 71 of the tripping device 70 until the entrainment element 73 is arranged in a concavity 77 that is configured in the region of the gear housing 12, wherein the portion 75 simultaneously bears axially against the carbon holder plate 50 and the gear housing 12, and the motor housing 28 on account thereof has reached the final position thereof on the gear housing 12.

The assembly position of the carbon holder plate 50 mentioned, in which the first end faces 54 of the carbon brushes 52, 53 are situated in the positions thereof that are spaced apart from the segments 19 of the collector 21 is illustrated in FIGS. 3, 4, and 7. In this position, the end portions 69 of the spring elements 62 bear in an abutting manner on the lateral surfaces 60 of the carbon brushes 52, 53. This has the effect that the carbon brushes 52, 53, on account of the spring force of the spring elements 62 within the guide elements 55, are pushed against the walls of the guide element 55 that face away from the lateral surfaces 60 such that friction-locked connections 78 are configured between the guide elements 55 and the carbon brushes 52, 53. Said friction-locked connections 78 must have a frictional resistance of such a magnitude that the carbon brushes 52, 53 cannot inadvertently move in the direction toward the longitudinal axis 32 of the armature shaft 24, that is to say in the direction toward the collector 21.

It can furthermore be seen by means of FIG. 4 that the contact faces 74 of the contact element 71 in the assembly position are situated at a spacing from the second end faces 59 of the carbon brushes 52, 53, or are not in contact so as to abut on the latter, respectively. As soon as the armature shaft 24, or the armature 20, respectively, has reached the axial end position thereof in which the segments 19 of the collector 21 are situated so as to be level with the guide elements 55, or the first end faces 54 of the carbon brushes 52, 53, respectively, it is effected during assembly of the morot housing 28 that the tripping device 70 is tripped, or actuated, respectively, on account of an abutting contact of the portion 75 of the motor housing 28 on the entrainment element 73. As a result, the contact faces 74 of the contact element 71 come into contact so as to abut on the second end faces 59 of the carbon brushes 52 and 53, according to the illustration of FIGS. 5, 6, 8, and 9, and in a further movement of the contact element 71 move said second end faces 59 in the direction of the longitudinal axes 57 of the guide elements 55 in the direction toward the collector 21. This in turn has the effect that the end portion 69 of the spring element 62 that are initially situated in the region of the lateral surface 60 make their way from the lateral surfaces 60 into the region of the second end faces 59 of the carbon brushes 52, 53, according to the illustration of FIGS. 8 and 9. As soon as this is the case, the spring force generated on the end portions 69 by the spring elements 62 is utilized for bringing the carbon brushes 52, 53 by way of the first end faces 54 thereof into contact in an abutting manner with the segments 19 of the collector 21, on account of which the assembly procedure with a view to configuring the commutator, or the electrical contacting of the carbon brushes 52, 53, respectively, is completed.

The carbon holder plate 50, or the electric motor 10, respectively, described above can be varied or modified, respectively, in many ways without deviating from the concept of the invention.

### LIST OF REFERENCE SIGNS

10 Electric motor
12 Gear housing
13 Output shaft
14 Gear cover
15 Connection region
16 Gear
17 Gear wheel
19 Segment
20 Armature
21 Collector
24 Armature shaft
26 Worm splining
28 Motor housing
29 Fastening screw
30 Threaded bore
31 Arrow
32 Longitudinal axis
33 Connector plug
50 Carbon holder plate
51 Through opening
52, 53 Carbon brush
54 First end face
55 Guide element
56 Opening cross section
57 Longitudinal axis
59 Second end face
60 Lateral surface
61 Lateral surface
62 Spring element
63 Connector braid
64 Suppression choke
65 Connector port
66 Portion
67 Appendage
68 Spring portion
69 End portion
70 Tripping device
71 Contact element
72 Spring portion
73 Entrainment element
74 Contact face
75 Portion
76 Arrow
77 Concavity
78 Friction-locked connection
79 Bevel
100 Windshield wiper motor

1. A carbon holder plate for an electric motor, with a guide element for a carbon brush, wherein the carbon brush is arranged longitudinally displaceable in the guide element in the direction of a longitudinal axis of the carbon brush, with a first end face of the carbon brush, which first end face is designed to lie against a collector of the electric motor, with a second end face lying opposite the first end face, against which second end face a spring element rests in a spring-loaded manner in an operating position, in order to press the carbon brush in the direction of the collector, and with a device for positioning a first end face of the carbon brush in an assembly position of the carbon holder plate at a distance from the collector, characterized in that
the device is formed by the spring element, wherein the spring element, in the assembly position, rests in a spring-loaded manner against an end face of the carbon brush and presses the carbon brush against the guide element thereby forming a friction-locked connection.

2. The carbon holder plate according to claim 1, characterized in that
a tripping device is provided, which with a contact element is arranged in a movable manner in an abutting contact against the second end face of the carbon brush, and which, upon contact with the second end face and further movement of the contact element, is designed to displace the contact brush in the guide element in the direction of the longitudinal axis, such that the spring element enters into an operative connection with the second end face of the carbon brush.

3. The carbon holder plate according to claim 2, characterized in that
the second end face and/or the contact element, in the abutting region between the carbon brush and the contact element, is/are arranged at an oblique angle (α, β) relative to the longitudinal axis or has a bevel.

4. The carbon holder plate according to claim 2, characterized in that
the contact element of the tripping device is arranged elastically by means of a spring portion.

5. The carbon holder plate according to claim 4, characterized in that
the carbon holder plate is made of plastic, and that the contact element is formed monolithically on the carbon holder plate over the spring portion.

6. The carbon holder plate according to claim 2, characterized in that
the tripping device comprises an entrainment element arranged in an operative connection with the contact element.

7. The carbon holder plate according to claim 1, characterized in that
the spring element comprises a curved contact portion, which can be placed both against the lateral surface as well as against the second end face of the carbon brush.

8. An electric motor with an armature comprising a collector and a carbon holder plate which is constituted according to claim 1.

9. The electric motor according to claim 8, characterized in that
the electric motor comprises a motor housing, which can be connected to a gear housing, and in that an actuating portion is provided, which can be positioned against a moveably arranged entrainment element of a tripping device.

10. The electric motor according to claim 9, characterized in that the actuating portion is formed by a portion of the motor housing.

11. A windshield wiper motor with an electric motor, which is constituted according to claim 9.

12. A method for assembling a windshield wiper motor according to claim 11, characterized in that
the assembly comprises at least the following steps:
pre-assembly of the carbon holder plate on the gear housing,
wherein the carbon brush is arranged in the assembly position axial joining of the armature and the motor housing in the direction towards the gear housing, wherein the armature is moved with a clearance past the carbon brush
bringing into contact and relative movement of the actuating portion with the entrainment element of the tripping device, wherein the carbon brush is moved in the guide element in the direction of the collector, and wherein the spring element comes into contact with the second end face of the carbon brush and presses the latter against the collector.
